(19) United States
(12) Patent Application Publication
(10) Pub. No.: US 2019/0066043 A1
(43) Pub. Date: Feb. 28, 2019

(54) METHOD AND SYSTEM FOR TRACKING PRODUCTS

(71) Applicant: John O'Neill McGinty, Cape Town (ZA)

(72) Inventors: John O'Neill McGinty, Cape Town (ZA); Ralph Harold James William Woods, Leicestershire (GB)

(21) Appl. No.: 16/084,686

(22) PCT Filed: Mar. 15, 2017
(86) PCT No.: PCT/IB2017/051492

§ 371 Date: Sep. 13, 2018

(30) Foreign Application Priority Data
Mar. 16, 2016 (ZA) 2016/01827

(51) Int. Cl. G06Q 10/08; G06F 17/30

(52) U.S. Cl. CPC G06Q 10/0833; G06F 17/30879; G06F 17/30241

(57) ABSTRACT

A remotely accessible server receives a request from a requesting device to release a product, the request including at least a product identifier and a geo-location. The server retrieves a product record associated with the product identifier from a database and then retrieves an expected geo-location from the product record. If the received geo-location substantially matches the expected geo-location of the product, the server updates the product record to mark the product as released and transmits a release instruction to the requesting device. If the received geo-location does not substantially match the expected geo-location of the product, the server updates the product record to mark the product as blocked and transmits a block instruction to the requesting device.

### CROSS-REFERENCE TO RELATED APPLICATION

This application claims priority from South African patent application number 2016/01827 filed on 16 Mar. 2016, which is incorporated by reference herein.

### FIELD OF THE INVENTION

The invention disclosed herein relates to the monitoring and tracking of manufactured products. More specifically, it relates to the monitoring and tracking of products throughout the supply chain.

### BACKGROUND TO THE INVENTION

Delivering a product from the manufacturer to the customer can be a very complex process. It may typically start with the procurement of raw materials for the manufacturing of the product from various suppliers. From there, the raw materials may be transported to a manufacturing plant where the product is manufactured, partially or to its final form. Subsequently, quality control, packaging and shipping to various distribution centres takes place. Ultimately, the final product is typically transported to outlets where the product is sold to the customer.

The various steps required to get products from the manufacturer to the customer and the parties involved at each step, of which only a few exemplary steps are mentioned above, is generally referred to as the supply chain. Supply chain management is a wide field wherein a lot of development has taken place in recent years. It comprises various different models and approaches, however, the term will be used herein to generally refer to the movement of products to and from different parties at various stages in the supply process. It should be noted that the movement of products may be bidirectional as products may move in a reverse direction along the supply chain in cases where incorrect products were delivered or products are returned, for example.

Due to the complexity of the modern supply chain, there exists a possibility that products may be shipped to an unintended location. This may be due to simple error or due to underhanded actions. It is therefore necessary to have an integrated system which enables an operator to verify whether a specific product is located at the correct location at a given point in time. The term “operator” is used generally herein to refer to any person, machine or system that may handle and/or process the product at various stages in the supply chain.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

In accordance with this invention there is provided a computerised method of tracking products and determining their status, the method carried out at a remotely accessible server and comprising:
receiving from a requesting device a request to release a product, the request including at least a product identifier and a geo-location;
retrieving a product record associated with the product identifier from a database;
retrieving an expected geo-location from the product record;
if the received geo-location substantially matches the expected geo-location of the product, updating the product record to mark the product as released and transmitting a release instruction to the requesting device; and
if the received geo-location does not substantially match the expected geo-location of the product, updating the product record to mark the product as blocked and transmitting a block instruction to the requesting device.

The method may include, prior to receiving a request to release a product, creating a product record and mapping the product identifier to the created product record; and populating the product record with at least an expected current geo-location. The method may include receiving product information from a product originating entity and using the received product information for creating the product record including supply chain information of multiple expected geo-locations.

Further features may provide for the product identifier to be integrated into one or more indicia on the product; the product identifier to further be integrated into indicia on one or more packaging containers associated with the product; for the indicia to be machine-readable codes; and for the machine-readable codes to be Quick Response (QR) codes.

Further features may provide for the requesting device to be a point of sale (POS) device with the POS device having a fixed geo-location or, alternatively, for the device to be a mobile code reader with a variable geo-location.

Receiving a request to release a product from a requesting device may include retrieving a requestor record from the database, the requestor record being associated with the requesting device; retrieving at least one allowed geo-location from the requestor record; determining whether the received geo-location is within an allowable tolerance from the at least one allowed geo-location; and if the received geo-location is not within an allowable tolerance, transmitting a block instruction to the requesting device.

Further features may provide for the packaging containers to have one or more levels of nested packaging containers contained therein; for the indicia of each nested packaging container to identify each sub-unit contained therein; and for each sub-unit to be a nested packaging container or, alternatively, a product.

The method may further include: determining a country of the geo-location of the requesting device by using the geo-location received from the requesting device to look up a country mapping; and blocking a product from exiting or entering a given country specified in the product record.

The invention extends to a system for tracking products and determining their status, comprising a remotely accessible server and the remotely accessible server comprising:
a database access component for providing an access connection between the remotely accessible server and a database associated with the system;
a database read component for retrieving data from the database, including product records and requestor records;
a database write component for writing data to the database or updating data on the database, including product records and requestor records;
a communication component for establishing a data connection between the remotely accessible server and a central network;
a request receiving component for receiving, from a requesting device, a request to release a product;
a checking component for determining whether a geo-location received from a requesting device substantially matches an expected geo-location retrieved from a product record associated with the product;
a release component for conditionally updating the product record to mark the product as released and transmitting a release instruction to the requesting device if the received geo-location does substantially match the expected geo-location; and
a blocking component for conditionally updating the product record to mark the product as blocked and transmitting a block instruction to the requesting device if the received geo-location does not substantially match the expected geo-location.

Further features of this aspect of the invention may provide for the remotely accessible server to furthermore include a record creating component for creating a product record associated with a product; a mapping component for mapping a product identifier to the product record; and a record populating component for populating the created product record with at least an expected geo-location.

The invention furthermore extends to a system for tracking products and determining their status, comprising a requesting device and the requesting device comprising:
a communication component for establishing a data connection between the requesting device and a central network;
a location component for determining the geo-location of the requesting device;
a scanning component for scanning one or more indicia associated with a product;
a decoder component for decoding the scanned indicia and determining from the decoded data at least a product identifier;
a requesting component for generating a request to release the product; and
an instruction receiving component for receiving instructions from a remotely accessible server.

The invention furthermore extends to a computer program product for tracking products and determining their status, the computer program product comprising a computer-readable medium having stored computer-readable program code for performing the steps of:
receiving from a requesting device a request to release a product, the request including at least a product identifier and a geo-location;
retrieving a product record associated with the product identifier from a database;
retrieving an expected geo-location from the product record;
if the received geo-location substantially matches the expected geo-location of the product, updating the product record to mark the product as released and transmitting a release instruction to the requesting device; and
if the received geo-location does not substantially match the expected geo-location of the product, updating the product record to mark the product as blocked and transmitting a block instruction to the requesting device.

Further features of this aspect of the invention may provide for the steps of, prior to receiving a request to release a product, creating a product record and mapping the product identifier to the created product record; and populating the product record with at least an expected current location.

In order for the invention to be more fully understood, implementations thereof will now be described with reference to the accompanying drawings.

### BRIEF DESCRIPTION OF THE DRAWINGS

The invention will now be described, by way of example only, with reference to the accompanying representations in which:

FIG. 1 is a schematic diagram which illustrates an exemplary system for tracking products and determining their status;

FIG. 2A is a swim-lane flow diagram which illustrates an exemplary method of tracking products and determining their status;

FIG. 2B is a swim-lane flow diagram which illustrates a further aspect of an exemplary method of tracking products and determining their status;

FIG. 3A is a block diagram which illustrates components of a remotely accessible server in an exemplary system for tracking products and determining their status;

FIG. 3B is a block diagram which illustrates further details of a database of the exemplary system of FIG. 3A;

FIG. 4A is a block diagram which illustrates components of a requesting device in an exemplary system for tracking products and determining their status;

FIG. 4B is a block diagram which illustrates the contents of a product identifier used in an exemplary system for tracking products and determining their status;

FIG. 5 is a block diagram which illustrates an example of a computing device in which various aspects of the disclosure may be implemented; and

FIG. 6 is a block diagram of an exemplary communication device that may be used in embodiments of the disclosure.

### DETAILED DESCRIPTION WITH REFERENCE TO THE DRAWINGS

Methods and systems of tracking products and determining their status are described. A data centre including a remotely accessible server may store product records as provided by a product producing or originating entity. The product record is used to track the product through the supply chain from the product originating entity until it is sold to an end customer.

During the course of the product's movement through the supply chain, the data centre may receive a request to release the product to a next location from a requesting device of a supply entity in the chain. The request may include a product identifier and a geo-location provided by the requesting device. The data centre may retrieve a product record associated with the product identifier from a database together with an expected geo-location from the product record. This enables the data centre to track the product and determine if it is in the correct geo-location compared to a planned supply chain. The system makes use of the product identifier and the geo-location to track products at each step or movement of the product life. Expected geo-locations of the product through the supply chain may be entered into the product record to be checked during the supply process.

If the received geo-location substantially matches the expected geo-location of the product, the product record may be updated to mark the product as released and a release instruction may be transmitted to the requesting device. On the other hand, if the received geo-location does not substantially match the expected geo-location of the product, the product record may be updated to mark the product as blocked and a block instruction may be transmitted to the requesting device. The product may be classified as follows: stolen for resale; fraudulent product; product sent to the incorrect client; or reconfirmed as a product at correct location and valid.

In addition, status requests may be made to the data centre to determine the status and/or location of a product. The product identifiers may include batch numbers such that batch shipment of products may be easily tracked and the product records updated by batches.

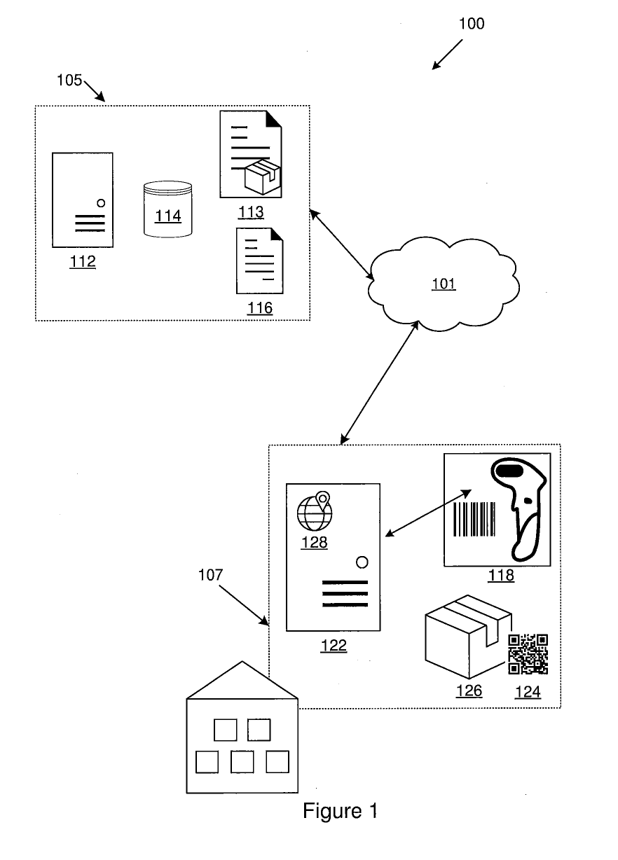

In accordance with this invention an embodiment of a system (100) for tracking products and determining their status is shown in FIG. 1. The system (100) includes a data centre (105) having a remotely accessible server (112) that is in data communication with a database (114). In one embodiment of the invention, the database (114) may be stored directly on the memory of the remotely accessible server (112). In another embodiment, the database (114) may be stored at a separate memory location to which the remotely accessible server (112) has access. Furthermore, in one embodiment of the invention the remotely accessible server (112) may be a single computing device. In another embodiment the remotely accessible server (112) may be a plurality of computing devices operating in concert.

The database may store product records (113), each product record (113) containing data entries relating to a product registered with the system (100). These data entries in the product records (113) may contain expected geo-locations of each of the products registered with the system (100). The database may further contain requestor records (116) including details of companies involved in the supply chain such as manufacturing entities, storage entities, sales entities, etc., each requestor record (116) containing data entries relating to a requesting device registered with the system (100). These data entries in the requestor records (116) may contain allowed geo-locations for requesting devices and may furthermore contain allowable tolerances from these allowed geo-locations.

Additionally, the database (114) may contain company records providing data relating to the product originating entity including contact details. Product records (113) may be linked to company records.

The requestor record (116) may be entered as part of a planned supply route for a product which may be compared to a product movement record that records details of product movements and where the product physically is at any stage of the supply chain. A status record may also be updated relating to the product movement record and providing a current status of a product if requested. Other records may also be stored at the database (114) including stock information records and marketing information records relating to the products.

The system (100) further includes a storage facility (107) having a requesting device (122) that is in data communication with a scanning component (118). The storage facility (107) may be a factory where products are manufactured; a warehouse wherein the products are kept for storage and/or distribution; a sales outlet where the product is sold to a reseller or an end-user; or any other facility at which the product may be located during different stages of the supply chain.

In the instance where the storage facility (107) is the factory, manufacturing entity, or other product originating entity, the requesting device (122) may be a computing device of the storage facility (107) that uploads a product record (113) to the remotely accessible server (112) for storing in the database (114). The requesting device (122) may also include or be in communication with a product identifier producing facility for producing the encoded product details as a product identifier (124) shown by indicia on the product (126) itself and/or incorporated into indicia shown on any packaging material that the product (126) may be packaged in. In one embodiment, the product identifier producing facility may be a bar code printer for printing the bar code onto the product (126) with the required, details.

Two-dimensional bar codes in the form of machine-readable codes such as Quick Response (QR) codes enable a large number of different pieces of information to be stored and scanned. Bar codes may be put onto products in the same way that expiry dates or existing bar codes are applied, eliminating the need to change packages or production methods.

At other stages of the supply chain, the requesting device (122) may be a handheld terminal equipped with an optical sensor such as a camera or barcode scanner fulfilling the function of the scanning component (118) or may be a computing device used in association with a separate scanning component (118). The requesting device (122) may furthermore be a mobile communication device equipped with a camera as scanning component (118) such as a mobile phone, tablet or the like. The requesting device (122) may even further be a point of sale (POS) device at a checkout counter of a sales outlet having an optical device such as a camera or barcode scanner as scanning component (118).

The requesting device (122) may include a geo-location (128) associated with the requesting device (122) which may be communicated to the data centre (105) when communicating with it, as explained further in detail below. The geo-locations (128) in the supply chain may be tracked as the product moves from one location to another. Fixed places such as factories, warehouses, shops, etc. may have fixed global positioning system (GPS) locations and these may be loaded into the product record (113) and company records of the manufacturer, distributor, or shop using the system.

A storage facility (107) may store various products, each product (126) having a product identifier (124) shown by indicia on the product itself and/or incorporated into indicia shown on any packaging material that the product may be packaged in. The product identifier may comprise a number of different fields, including a company logo, a serial number in the form of a product code, a batch number, date of manufacture, date of expiry, references to other resources such as a Universal Resource Locator (URL) for product verification, and the like. In addition, the product identifier may include hidden details which are only accessible by the data centre (105) and a product originator such as an item number of a batch and a unique internal product code. It will be appreciated by those skilled in the art that numerous other data fields may be included herein. In an embodiment of the invention, the product identifier may be a matrix barcode or 2-dimensional barcode.

The requesting device (122) at the storage facility (107) and the remotely accessible server (112) at the data centre (105) may be in bidirectional data communication via a network (101). In one embodiment, the network (103) may be the Internet. In an alternative embodiment, the network (103) may be a private network, such as a local area network (LAN), a private Access Point Network (APN) or the like. These and various other network technologies and topologies are well known and it will be appreciated to those skilled in the art that the central network may comprise any or a combination of these network technologies. Additionally, the data centre (105) may be provided as a cloud-based service for monitoring the movement of the products though the supply chain as a remotely provided service.

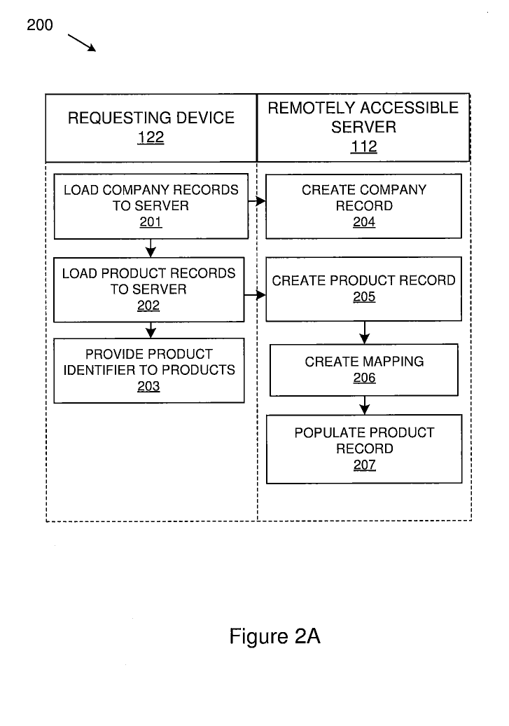

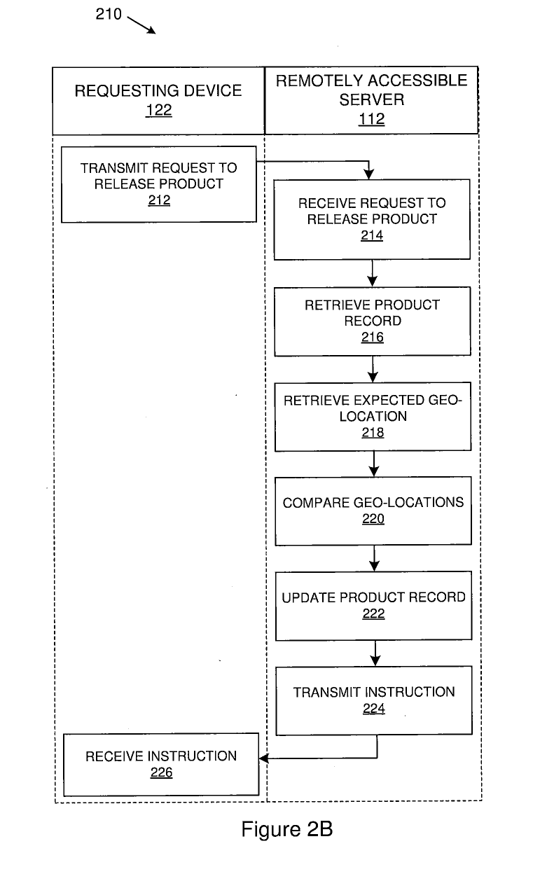

The swim-lane flow diagram (200) shown in FIG. 2A shows an aspect of an exemplary method of tracking products and determining their status. The method shown in this flow diagram (200) may be a precursor to the exemplary method shown in the swim-lane flow diagram (210) of FIG. 2B and may be implemented to record data relating to a product onto the database (114) associated with the remotely accessible server (112). This diagram serves to illustrate the interaction between a requesting device (122), in this case an originating entity of the product, and a remotely accessible server (112) and the actions that may be performed at each of these devices. Reference to interaction with the server (112) should be considered to include access to the database (114) associated with the server (112) as required.

The requesting device (122) in the form of an originating entity of the product may load (201) company records to the server (112) for the originating entity. Company records provide all details relating to the company and may include an on/off flag to turn company records on and off to enable companies to opt in or out of the system at any stage. The company records may include information including: a list of products manufactured, where the products are manufactured, product identifies, how products are packed and packaged in order to coordinate mass scan of a pallet, etc., contact information, countries they operate in, GPS of locations of the supply chain.

The requesting device (122) may also load (202) product records onto the system which may be linked to a company record. Product records may relate to a product type may have an on/off flag as products become discontinued or new products become available. The product records may include expected product movement details including geo-locations of the supply chain locations. These expected locations may be compared to a product movement record that may generated during the supply chain to record details of the product movements and where the product is at any stage.

The GPS locations of manufacture and where the goods are sent to may be recorded by the server (112) and all requesting devices of subsequent supply chain entities may need to verify their GPS location to make sure this is correct when they activate their scanner.

As the product is produced, the requesting device (122) may provide (203) a product identifier, for example, it may have a bar code printed onto it, with details corresponding to the product record. Movement of the product may result in the method shown in FIG. 2B including updates to the movement record of the product with GPS details of each entity in the supply chain it passes through. These details may be kept private to the server (112). In addition, a product that is on the system may have its record accessed at the server to provide a status of the product.

The product records may be inserted into the system online or via a client application at the requesting device or, if the volumes are large, as a file sent via a file transport protocol (FTP) which may be loaded remotely at the server (112). Updates to the movements of the products may be recorded into the system as described in FIG. 2B online or via a client application at the requesting device, such as a scanning application.

The remotely accessible server (112) may create (204) a company record and may create (205) a product record (113) to be stored in the database (114). The server (112) may create (206) a mapping between the created product record (113) and a product identifier (124) of the product associated with the created product record (113). It may furthermore populate (207) the created product record (113) with at least an expected current geo-location of the product associated with the created product record (113).

The server (112) may provide a dashboard to a requesting device (122) of the originating entity for monitoring products. This may enable the requesting device (122) to add new company records, de-activate or re-activate company records, add new product records, de-activate product records, change company contact details, and block/unblock countries to scan given products.

The server (112) may also be able to keep track of and provide additional information relating to the products of a company including: stock counts, stock rotation information, market share per store or region, and an initial value to determine validity of stock or goods.

The swim lane flow diagram (210) shown in FIG. 2B illustrates an exemplary method of tracking products and determining their status using the system (100) shown in FIG. 1. This diagram serves to illustrate the interaction between a requesting device (122) of an entity along the supply chain and the remotely accessible server (112) and the actions that may be performed at each of these devices. Although the diagrams indicate an order wherein the actions are performed, this should not be construed as limiting or binding as these actions may be performed in any logical order which effects the desired result.

The requesting device (122) may transmit (212) a request to release a product (126) to the remotely accessible server (112) whereafter the request is received (214) by the remotely accessible server (112). This request includes at least a product identifier (124) associated with the product (126) and a geo-location (128) associated with the requesting device (122). The remotely accessible server (112) may then, from the database (114), retrieve (216) a product record (113) associated with the received product identifier (124) and retrieve (218), from the product record (113) an expected geo-location of the product. The remotely accessible server (112) will then compare (220) the geo-location (128) received in the request from the requesting device (122) with the expected geo-location of the product retrieved from the product record (113).

If this comparison shows the received geo-location to substantially match the expected geo-location, the remotely accessible server (112) may update (222) the product record (113) to indicate that the product may be released and transmit (224) a release instruction to the requesting device (122). Alternatively, if the comparison shows the received geo-location does not substantially match the expected location, the remotely accessible server (112) will update the product record (113) to indicate a blocked status for the product and may transmit (224) a block instruction to the requestor device (122). The requesting device (122) will subsequently receive (226) the instruction sent by the remotely accessible server (112).

In addition to the geo-location verification of the supply chain, the geo-location check may also verify the country the product is in via a geo-location look up. This may use GPS data with border information for countries. The originating entity may block products from exiting or entering a given country using the described system.

An entity along the supply chain may scan a product in when it arrives and out once the product leaves its location. The entity may use their requesting device (122) to send a request and update to the server (112) including a request to transmit the product when it is being scanned out of the location. The transmission of products into or out of a location may only be authorised if the geo-location of the product record substantially matches that of the scanning device.

Once the product is sold from a final retail outlet of the supply chain, the retail outlet entity may transmit a request to terminate the tracking record of the product.

A requesting device (122) of one entity may also scan products at other locations to check if the product is valid or a fraudulent product. This information may be sent to an administrator to maintain confidentiality of the supply chain but may use the requesting devices of intermediate locations to obtain product information.

The products may be scanned in batches with a single scan referencing multiple product instances of a product type. The product originating entity may provide details of how each product is packed, for example, how many boxes per carton and how many carton per pallet, etc. A scan of the product identifier of a product may identify the pallet it is from. Inversely, a scan of a pallet may identify the sequence numbers of the products in the pallet. This enables mass scans from a single bar code of a pallet.

The longer the system is in use, the harder it is for fraud and “internal” theft to take place and to identify goods in the incorrect locations. This may particularly prevent goods being stolen for resale by another entity.

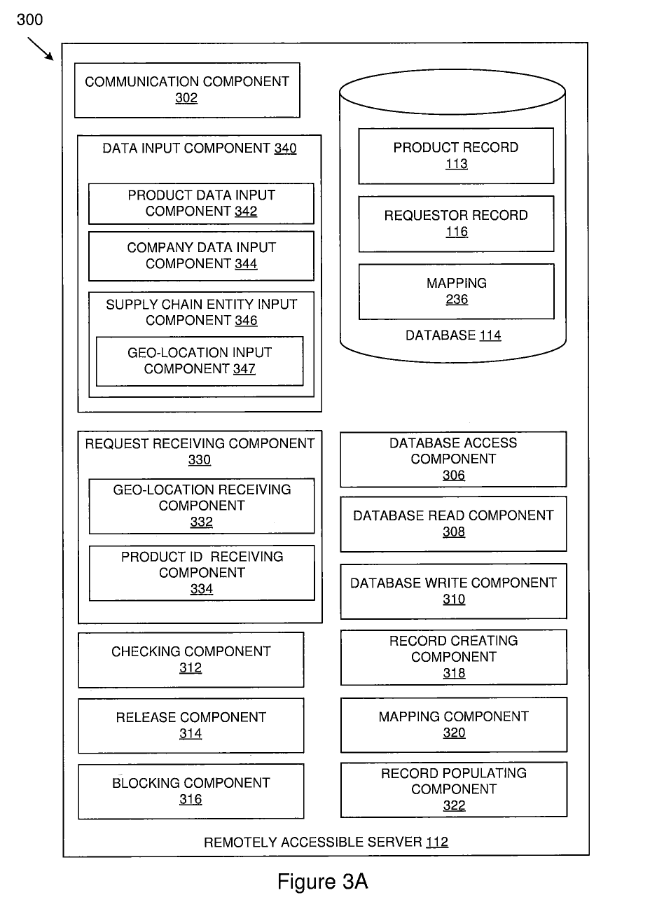

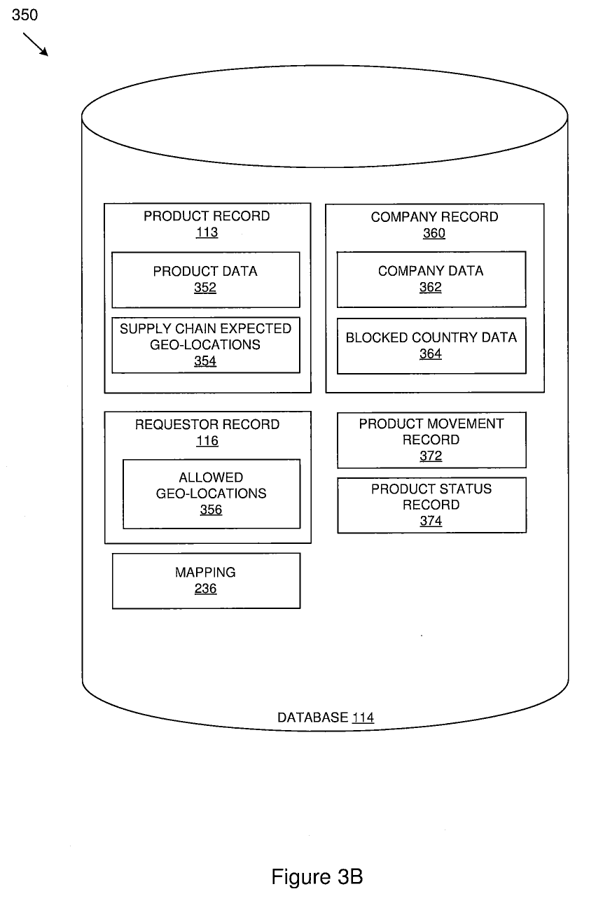

The block diagram (300) of FIG. 3 illustrates a first aspect of an exemplary system for tracking products and determining their status in the form of a remotely accessible server (112) of a data centre (105).

The remotely accessible server (112) may include at least one processor, a hardware module, or a circuit for executing the functions of the described components which may be software units executing on the at least one processor, hardware module, or circuit. Multiple processors running parallel processing threads may be provided enabling parallel processing for some or all of the functions of the components. Memory may be configured to provide computer instructions to the at least one processor to carry out the functionality of the components. The remotely accessible server (112) may have an access connection to a database (114) for storing data as records used by the system.

The remotely accessible server (112) may include a communication component (302) for a data connection to a central network (101).

The remotely accessible server (112) may include a data input component (340) for receiving data input from a requesting device of a product originating entity. The data input component (340) may include a product data input component (342) for receiving product data that may be used to create a product record (113) and a company data input component (344) for receiving company data that may be used to create a company record.

The data input component (340) may also include a supply chain entity input component (346) for receiving supply chain entity data from the product originating entity prescribing the supply chain and the entities that will handle the product from production to sale. The supply chain entity input component (346) may include a geo-location input component (347) for receiving expected geo-locations for the supply chain. The supply chain entity data may also be used to populate the product record (113).

The remotely accessible server (112) may further include a request receiving component (330) for receiving, from a requesting device (122), a request to release a product. The request receiving component (330) may include a geo-location receiving component (332) for receiving a current geo-location from a requesting device and product identifier receiving component (334) for receiving a product identifier from the requesting device.

The remotely accessible server (112) may include a database access component (306) for providing an access connection between the remotely accessible server (112) and the database (114) associated with the system. It may further include a database read component (308) for retrieving data from the database, including product records (113), requestor records (116) and mapping (236) data and a database write component (310) for writing data to the database (114) or updating data on the database, including product records (113), requestor records (116) and mapping (236) data.

The remotely accessible server (112) may include a checking component (312) for determining whether a geo-location received from a requesting device (122) substantially matches an expected geo-location retrieved from a product record (113) associated with the product. It may further include a release component (314) for conditionally updating the product record (113) to mark the product as released and transmitting a release instruction to the requesting device (122) if the received geo-location does substantially match the expected geo-location and a blocking component for conditionally updating the product record (113) to mark the product as blocked and transmitting a block instruction to the requesting device (122) if the received geo-location does not substantially match the expected geo-location.

The remotely accessible server (112) may furthermore include a record creating component (318) for creating a product record (113) associated with a product (126); a mapping component (320) for mapping (236) a product identifier (124) to the product record (113); and a record populating component (322) for populating the created product record (113) with at least an expected geo-location.

Referring to FIG. 3B, a block diagram (350) shows further details of the database (114). As previously described, the database (114) may include product records (113) which may contain product data (352) including the product identifiers and supply chain expected geo-locations (354). The database (114) may also include requestor records (116) for data entities involved in the supply chain including allowed geo-locations (356) for requesting devices. The database (114) may also include mappings (236) of product identifiers to product records.

In addition, the database (114) may store company records (360) for product originating entities. The company records (360) may include company data (362) such as contact details, their product details manufactured and where, how products are packed and packaged, and blocked country data (364) relating to countries they operate in.

The product records (113) and the company records (360) may have on/off flags to indicate if a company record (360) is opted in or out of the system and if the product record (113) is for a currently available product.

The database (114) may also include a product movement record (372) which is updated to record details of the products' movements and where a product is at any stage of the supply chain. The database (114) may also include a product status record (374) for updating a status of a product for access by a requesting device.

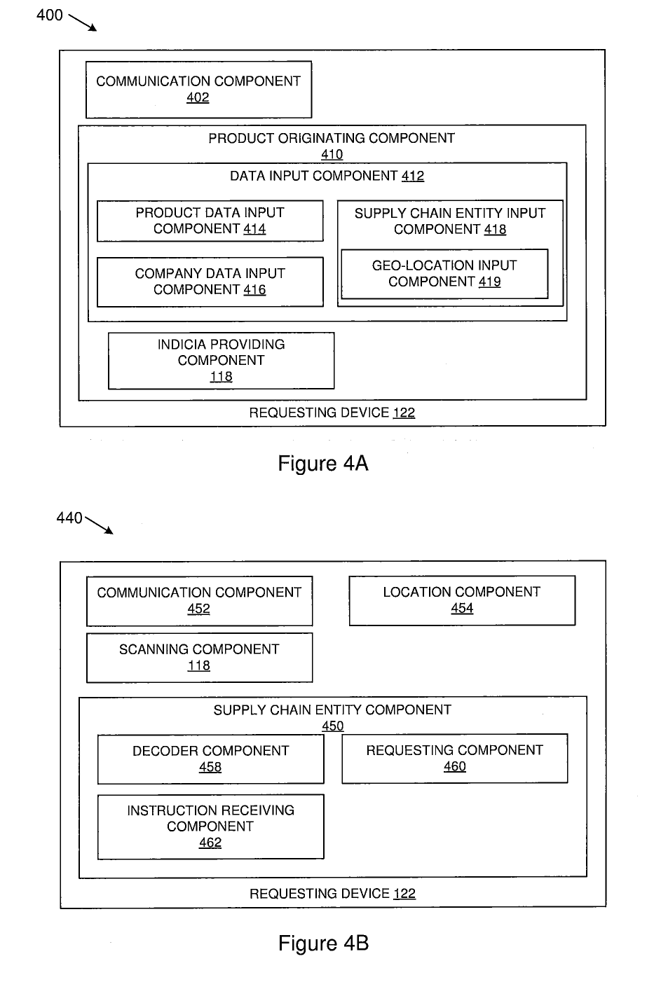

The block diagram (400) of FIG. 4A illustrates a further aspect of an exemplary system for tracking products and determining their status in the form of a requesting device (122) of a product originating entity.

The requesting device (122) may include a communication component (402) for establishing a data connection between the requesting device (122) and a central network (101) for communication with the remotely accessible server (112).

The requesting device (122) may include a product originating component (410) which may be in the form of an application which may operate on the requesting device (122) of a product originating entity. The product originating component (410) may include a data input component (412) for data input to the remotely accessible server (112). The data input component (412) may include a product data input component (414), a company data input component (416) and a supply chain entity input component (418) having a geo-location input component (419). These components may correspond to and communicate with the data input component (340) of the remotely accessible server (112).

The product originating component (410) may also include an indicia providing component (118) for generating indicia for attachment to products and packaging originating at the entity.

The block diagram (440) of FIG. 4B illustrates a further aspect of an exemplary system for tracking products and determining their status in the form of a requesting device (122) of a storage facility (107) or other entity in the supply chain.

The requesting device (122) may be a mobile communication device of an operator, such as a mobile phone, tablet, PDA and the like and may also be a handheld terminal. These exemplary devices will, by virtue of their mobility, not have a fixed geo-location associated therewith. Accordingly, the system (100) may provide for a plurality of allowed geo-locations for these exemplary devices and may allow a predetermined deviation tolerance for each of these allowed geo-locations. The requesting device (122) may furthermore be a point of sale (POS) device or a computing device such as a personal computer of an operator or a server of an enterprise to name but a few exemplary computing devices.

The requesting device (122) may include a communication component (452) for establishing a data connection between the requesting device (122) and a central network (101) for connection to the remotely accessible server (112).

It may furthermore include a location component (454) for determining the geo-location (128) of the requesting device (122). It may include a scanning component (118) for scanning one or more indicia (124) associated with a product (126).

The requesting device (122) may include a supply chain entity component (450) which may be in the form of an application which may operate on the requesting device (122) of a supply chain entity. The supply chain entity component (450) may include a decoder component (458) for decoding the scanned indicia (124) and determining from the decoded data at least a product identifier. The supply chain entity component (450) may include a requesting component (460) for generating a request to release the product (126) and an instruction receiving component (462) for receiving instructions from a remotely accessible server (112).

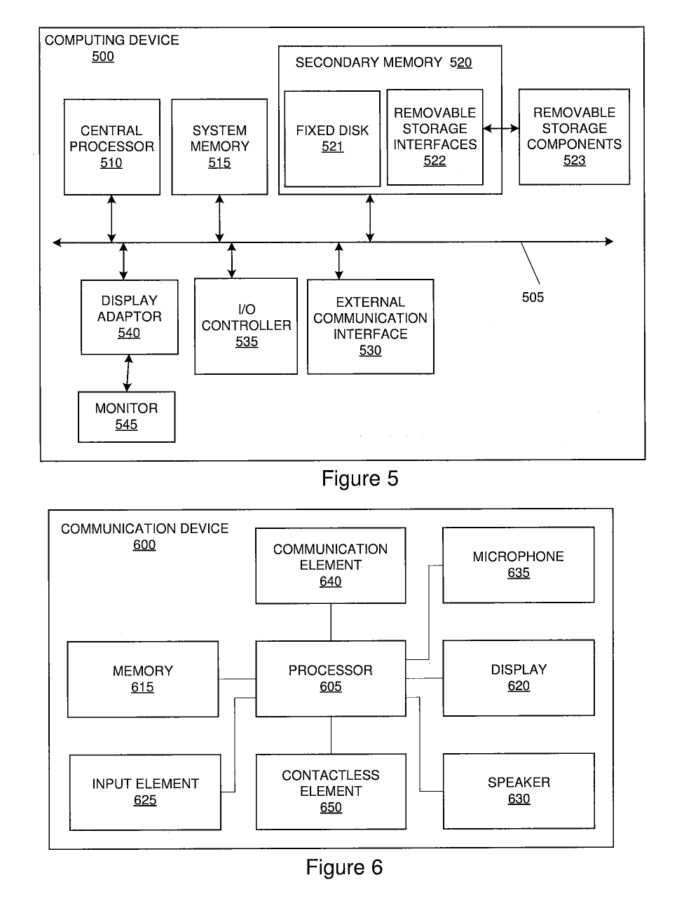

FIG. 5 illustrates an example of a computing device (500) in which various aspects of the disclosure may be implemented. The computing device (500) may be suitable for storing and executing computer program code. The various participants and elements in the previously described system diagrams may use any suitable number of subsystems or components of the computing device (500) to facilitate the functions described herein.

The computing device (500) may include subsystems or components interconnected via a communication infrastructure (505) (for example, a communications bus, a cross-over bar device, or a network). The computing device (500) may include at least one central processor (510) and at least one memory component in the form of computer-readable media.

The memory components may include system memory (515), which may include read only memory (ROM) and random access memory (RAM). A basic input/output system (BIOS) may be stored in ROM. System software may be stored in the system memory (415) including operating system software.

The memory components may also include secondary memory (520). The secondary memory (520) may include a fixed disk (521), such as a hard disk drive, and, optionally, one or more removable-storage interfaces (522) for removable-storage components (523).

The removable-storage interfaces (522) may be in the form of removable-storage drives (for example, magnetic tape drives, optical disk drives, floppy disk drives, etc.) for corresponding removable storage-components (for example, a magnetic tape, an optical disk, a floppy disk, etc.), which may be written to and read by the removable-storage drive.

The removable-storage interfaces (522) may also be in the form of ports or sockets for interfacing with other forms of removable-storage components (523) such as a flash memory drive, external hard drive, or removable memory chip, etc.

The computing device (500) may include an external communications interface (530) for operation of the computing device (500) in a networked environment enabling transfer of data between multiple computing devices (500). Data transferred via the external communications interface (530) may be in the form of signals, which may be electronic, electromagnetic, optical, radio, or other types of signal.

The external communications interface (530) may enable communication of data between the computing device (500) and other computing devices including servers and external storage facilities. Web services may be accessible by the computing device (500) via the communications interface (530).

The external communications interface (530) may also enable other forms of communication to and from the computing device (500) including, voice communication, near field communication, Bluetooth, etc.

The computer-readable media in the form of the various memory components may provide storage of computer-executable instructions, data structures, program modules, and other data. A computer program product may be provided by a computer-readable medium having stored computer-readable program code executable by the central processor (510).

A computer program product may be provided by a non-transient computer-readable medium, or may be provided via a signal or other transient means via the communications interface (530).

Interconnection via the communication infrastructure (505) allows a central processor (510) to communicate with each subsystem or component and to control the execution of instructions from the memory components, as well as the exchange of information between subsystems or components.

Peripherals (such as printers, scanners, cameras, or the like) and input/output (I/O) devices (such as a mouse, touchpad, keyboard, microphone, joystick, or the like) may couple to the computing device (500) either directly or via an I/O controller (535). These components may be connected to the computing device (500) by any number of means known in the art, such as a serial port.

One or more monitors (545) may be coupled via a display or video adapter (540) to the computing device (500).

FIG. 6 shows a block diagram of a communication device (600) that may be used in embodiments of the disclosure. The communication device (600) may be a cell phone, a feature phone, a smart phone, a satellite phone, or a computing device having a phone capability.

The communication device (600) may include a processor (605) (e.g., a microprocessor) for processing the functions of the communication device (600) and a display (620) to allow a user to see the phone numbers and other information and messages. The communication device (600) may further include an input element (625) to allow a user to input information into the device (e.g., input buttons, touch screen, etc.). The input element (625) may also be an optical input device, such as a camera or barcode scanner. The communication device may further include a speaker (630) to allow the user to hear voice communication, music, etc., and a microphone (635) to allow the user to transmit his or her voice through the communication device (600).

The processor (605) of the communication device (600) may connect to a memory (615). The memory (615) may be in the form of a computer-readable medium that stores data and, optionally, computer-executable instructions.

The communication device (600) may also include a communication element (640) for connection to communication channels (e.g., a cellular telephone network, data transmission network, Wi-Fi network, satellite-phone network, Internet network, Satellite Internet Network, etc.). The communication element (640) may include an associated wireless transfer element, such as an antenna.

The communication element (640) may include a subscriber identity module (SIM) in the form of an integrated circuit that stores an international mobile subscriber identity and the related key used to identify and authenticate a subscriber using the communication device (600). One or more subscriber identity modules may be removable from the communication device (600) or embedded in the communication device (600).

The communication device (600) may further include a contactless element (650), which is typically implemented in the form of a semiconductor chip (or other data storage element) with an associated wireless transfer element, such as an antenna. The contactless element (650) may be associated with (e.g., embedded within) the communication device (600) and data or control instructions transmitted via a cellular network may be applied to the contactless element (650) by means of a contactless element interface (not shown). The contactless element interface may function to permit the exchange of data and/or control instructions between mobile device circuitry (and hence the cellular network) and the contactless element (650).

The contactless element (650) may be capable of transferring and receiving data using a near field communications (NFC) capability (or near field communications medium) typically in accordance with a standardized protocol or data transfer mechanism (e.g., ISO 14443/NFC). Near field communications capability is a short-range communications capability, such as radio-frequency identification (RFID), Bluetooth, infra-red, or other data transfer capability that can be used to exchange data between the communication device (600) and an interrogation device. Thus, the communication device (600) may be capable of communicating and transferring data and/or control instructions via both a cellular network and near field communications capability.

The data stored in the memory (615) may include: operation data relating to the operation of the communication device (600), personal data (e.g., name, date of birth, identification number, etc.), financial data (e.g., bank account information, a bank identification number (BIN), credit or debit card number information, account balance information, expiration date, loyalty provider account numbers, etc.), transit information (e.g., as in a subway or train pass), access information (e.g., as in access badges), etc. A user may transmit this data from the communication device (600) to selected receivers.

The communication device (600) may be, amongst other things, a notification device that can receive alert messages and access reports, a portable merchant device that can be used to transmit control data identifying a discount to be applied, as well as a portable consumer device that can be used to make payments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The software components or functions described in this application may be implemented as software code to be executed by one or more processors using any suitable computer language such as, for example, Java, C++, or Perl using, for example, conventional or object-oriented techniques. The software code may be stored as a series of instructions, or commands on a non-transitory computer-readable medium, such as a random access memory (RAM), a read-only memory (ROM), a magnetic medium such as a hard-drive or a floppy disk, or an optical medium such as a CD-ROM. Any such computer-readable medium may also reside on or within a single computational apparatus, and may be present on or within different computational apparatuses within a system or network.

Any of the steps, operations, or processes described herein may be performed or implemented with one or more hardware or software modules, alone or in combination with other devices. In one embodiment, a software module is implemented with a computer program product comprising a non-transient computer-readable medium containing computer program code, which can be executed by a computer processor for performing any or all of the steps, operations, or processes described.

Throughout the specification and claims unless the contents requires otherwise the word ‘comprise’ or variations such as ‘comprises’ or ‘comprising’ will be understood to imply the inclusion of a stated integer or group of integers but not the exclusion of any other integer or group of integers.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computerised method of tracking products and determining their status, the method carried out at a remotely accessible server and comprising:
receiving from a requesting device a request to release a product, the request including at least a product identifier and a geo-location;
retrieving a product record associated with the product identifier from a database;
retrieving an expected geo-location from the product record;
if the received geo-location substantially matches the expected geo-location of the product, updating the product record to mark the product as released and transmitting a release instruction to the requesting device; and
if the received geo-location does not substantially match the expected geo-location of the product, updating the product record to mark the product as blocked and transmitting a block instruction to the requesting device.

2. A method as claimed in claim 1 including, prior to receiving a request to release a product: creating a product record and mapping the product identifier to the created product record; and populating the product record with at least an expected current geo-location.

3. A method as claimed in claim 2 including receiving product information from a product originating entity and using the received product information for creating the product record including supply chain information of multiple expected geo-locations.

4. A method as claimed in claim 1 wherein the product identifier is integrated into one or more indicia on the product or on one or more packaging containers associated with the product.

5. A method as claimed in claim 4 wherein the indicia are machine-readable codes.

6. A method as claimed in claim 1 wherein the requesting device is a point of sale (POS) device with the POS device having a fixed geo-location.

7. A method as claimed in claim 1 wherein the requesting device is a mobile code reader with a variable geo-location.

8. A method as claimed in claim 1 wherein receiving from a requesting device a request to release a product further includes: retrieving a requestor record from the database, the requestor record being associated with the requesting device; retrieving at least one allowed geo-location from the requestor record; determining whether the received geo-location is within an allowable tolerance from the at least one allowed geo-location; and if the received geo-location is not within an allowable tolerance, transmitting a block instruction to the requesting device.

9. A method as claimed in claim 4 wherein the packaging containers have one or more levels of nested packaging containers contained therein; the indicia of each nested packaging container identifies each sub-unit contained therein; and each sub-unit is selected from the group comprising a nested packaging container; and a product.

10. A method as claimed in claim 1 including:
determining a country of the geo-location of the requesting device by using the geo-location received from the requesting device to look up a country mapping; and
blocking a product from exiting or entering a given country specified in the product record.

11. A system for tracking products and determining their status, comprising a remotely accessible server and the remotely accessible server comprising:
a database access component for providing an access connection between the remotely accessible server and a database associated with the system;
a database read component for retrieving data from the database, including product records and requestor records;
a database write component for writing data to the database or updating data on the database, including product records and requestor records;
a communication component for establishing a data connection between the remotely accessible server and a central network;
a request receiving component for receiving, from a requesting device, a request to release a product;
a checking component for determining whether a geo-location received from a requesting device substantially matches an expected geo-location retrieved from a product record associated with the product;
a release component for conditionally updating the product record to mark the product as released and transmitting a release instruction to the requesting device if the received geo-location does substantially match the expected geo-location; and
a blocking component for conditionally updating the product record to mark the product as blocked and transmitting a block instruction to the requesting device if the received geo-location does not substantially match the expected geo-location.

12. A system as claimed in claim 11 wherein the remotely accessible server includes a record creating component for creating a product record associated with a product; a mapping component for mapping a product identifier to the product record; and a record populating component for populating the created product record with at least an expected geo-location.

13. A system as claimed in claim 11, comprising a requesting device and the requesting device comprising:
a communication component for establishing a data connection between the requesting device and a central network;
a location component for determining the geo-location of the requesting device;
a scanning component for scanning one or more indicia associated with a product;
a decoder component for decoding the scanned indicia and determining from the decoded data at least a product identifier;
a requesting component for generating a request to release the product; and
an instruction receiving component for receiving instructions from a remotely accessible server.

14. A computer program product for tracking products and determining their status, the computer program product comprising a computer-readable medium having stored computer-readable program code for performing the steps of:
receiving from a requesting device a request to release a product, the request including at least a product identifier and a geo-location;
retrieving a product record associated with the product identifier from a database;
retrieving an expected geo-location from the product record;
if the received geo-location substantially matches the expected geo-location of the product, updating the product record to mark the product as released and transmitting a release instruction to the requesting device; and
if the received geo-location does not substantially match the expected geo-location of the product, updating the product record to mark the product as blocked and transmitting a block instruction to the requesting device.

15. A computer program product as claimed in claim 14 further including stored computer-readable program code for performing the the steps of, prior to receiving a request to release a product, creating a product record and mapping the product identifier to the created product record; and populating the product record with at least an expected current location.
